(19) United States
(12) Patent Application Publication
(10) Pub. No.: US 2022/0227408 A1
(43) Pub. Date: Jul. 21, 2022

(54) DISPOSABLE SANITARY COVER

(71) Applicant: Herbert Glimcher, Bexley, OH (US)

(72) Inventor: Herbert Glimcher, Bexley, OH (US)

(21) Appl. No.: 17/579,859

(22) Filed: Jan. 20, 2022

Related U.S. Application Data
(60) Provisional application No. 63/139,637, filed on Jan. 20, 2021.
(60) Provisional application No. 63/175,958, filed on Apr. 16, 2021.

(51) Int. Cl. B62B 5/06; B65D 83/08; G09F 23/00

(52) U.S. Cl. CPC B62B 5/069; G09F 23/0081; B65D 83/0894

(57) ABSTRACT

A disposable sanitary cover adapted to cover the contact surface of a handle of a device having a contact surface, wherein the disposable sanitary cover includes an upper side, a left side, a right side and a bottom such that that the disposable sanitary cover forms a box shape that is open on one end. The disposable sanitary cover is adapted to engage a handle and cover a substantial portion of said contact surface thereof and the disposable sanitary cover comprises an inner surface and an outer surface.

### CROSS REFERENCE TO RELATED APPLICATIONS

This application claims priority to U.S. Provisional Application No. 63/139,637 filed on Jan. 20, 2021, titled “DISPOSABLE HANDLE COVER FOR USE WITH SHOPPING CARTS, STROLLERS AND BASKETS” and U.S. Provisional Application No. 63/175,958 filed on Apr. 16, 2021, titled “DISPOSABLE SANITARY COVER,” which are hereby incorporated in their entirety herein by reference.

### BACKGROUND

Each day, dozens of individuals may touch the handle of an individual public shopping cart, other cart, stroller, basket or other item with handles. Individuals who are sick may cough or sneeze on the handles, and germs of other consumers can be transferred to the public cart handles, stroller handles, basket handles or other handles. Therefore, every time a consumer is shopping or performing other day-to-day activities and uses a public cart, stroller, basket or other item with handles, the consumer can be exposed to dirt and to a great number of viruses, bacteria and other pathogens, including but not limited to the COVID-19 virus. Given the impact of the COVID-19 pandemic around the world, the high communicability of the COVID-19 virus, and the myriad of possible adverse health effects, including death, stemming from the COVID-19 virus and other pathogens, it is prudent to exercise care with objects that are often touched by members of the public.

The present disclosure offers a sanitary and disposable solution to neutralize the health risks encountered each time a consumer touches the handle on a cart, stroller, basket or other item. This disclosure will be a disposable and inexpensive solution that stores can offer to their customers as an easy-to-use protective solution to the risks of the COVID-19 virus and other pathogens. Grocery, hardware and department stores have recognized such risks and either place disposable wipes near the shopping carts, public strollers or baskets so that consumers can wipe the handles themselves, or use an employee to wipe down the handles of each cart, stroller or basket after use. Such wipes or wiping can leave a wet surface that still contains pathogens. Or the wiping may not be performed or performed incorrectly, leaving pathogens. The device of the present disclosure offers a barrier against any viruses, bacteria or other pathogens that may be present on such handles.

In addition to handles, individuals may desire protection from germs or pathogens in other settings. Including public seating, steering wheels, tables, or any other setting where a user may contact surfaces which are used by other members of the public.

### SUMMARY

The present disclosure includes disclosure of a one-ply or multiple-ply synthetic or natural material in a generally bag shape that may or may not have elastic properties. The bag may be formed of rectangular sheets of material with a defined upper side, lower side, left side, right side and bottom, such that it is a box shape. In some embodiments, any one or more of the sides or bottom may be replaced by a seam (for example, two rectangular sheets that are joined on three edges to form a bag). Multiple-ply materials may have two or more plies with different characteristics, such as a plastic, paper, fabric or other synthetic or natural material, optionally with an adhesive-coated layer bonded to a fabric layer that can be treated with an anti-viral or anti-bacterial sub stance.

The plastics that may be used to produce covers in accordance with the present disclosure may include those that provide sufficient elasticity to permit the cover to be stretched and urged over the handle of the shopping cart, public stroller, basket or other item. Such plastics may include high-density polyethylene (HDPE), medium-density polyethylene (MDPE), low-density polyethylene (LDPE), linear low-density polyethylene (LLDPE), polypropylene (PP), and degradable olefinic polymers. HDPE is usually milky white or semi-translucent, has superior puncture and temperature resistance, low permeability, and is more rigid and stronger than LDPE/LLDPE. HDPE, however, also tears more easily and has a propensity to crinkle compared to other polymeric materials. HDPE is often chosen for its high strength and low cost. MDPE is less opaque than HDPE but not as clear as LDPE. MDPE is usually stronger than LDPE of equal thickness, but does not stretch as much. This type of polyethylene is used on a much smaller scale than HDPE and is often used for consumer packaging.

Items made from LDPE are either white in color or clear, and is often chosen for consumer packaging where strength is not a requirement. Items made from this material are very flexible and easy to stretch and are clear and glossy. They also have good tear resistance and good moisture barrier properties but only fair gas barrier properties.

LLDPE has similar properties as LDPE and finds uses for similar applications. However, there are some differences that make LLDPE preferable for different applications. For example, LLDPE is selected for its higher tensile and impact strength and better heat sealability, whereas LDPE is often selected for its higher clarity, ease of processing and higher gloss.

Polypropylene (PP) is a thermoplastic of high clarity, high gloss, good tensile strength, excellent chemical and heat resistance. It has a higher melting point than PE which makes it suitable for applications that require sterilization at high temperatures. Like PVC it has low gas permeability, i.e. it is not breathable, and is easy to heat seal. PP is often chosen for food packaging where low permeability, heat sealing and high clarity is advantageous or required like bags for candies, cookies, herbs, nuts and other confectionaries.

Degradable bags (also known as oxo-degradable or UV degradable bags) have lately gained increased of attention. These plastic bags are often based on degradable polyethylene which contains additives (organic transition metal compounds) and/or degradable monomers that cause the plastic to break down slowly when exposed to sunlight, moisture, and oxygen.

The plastic materials may be formed from one or more layers of these plastics in order to achieve the desired physical characteristics required for the cover on the present disclosure.

The plastics that may be used to produce covers in accordance with the present disclosure may be of sufficient thinness to obtain the desired physical characteristics depending upon the size and shape of the handle of the shopping cart, public stroller, basket, steering wheels, public seating, public tables, or other item to which the cover is to be applied, and with due regard to the elasticity of the plastic selected and the typical hand force required to stretch the plastic cover in order to place it in the desired position thereover, and to remove it after use.

The device of the present disclosure may have a pressure-sensitive adhesive coating on the side of the cover that contacts the surface to which the device is applied, such as a handle on a shopping cart, public stroller, basket or other item. The device may or may not include a release liner that is removed prior to installing the cover or may have an adhesive strip attached to the cover. The cover can be inverted and placed over the entire handle and lowered so that the handle fits inside the cover. The cover will stay in place due to friction or snugness. If any adhesive is included, the adhesive could be used to hold, or help hold, the cover in place. The cover can be easily removed by grasping the cover lifting off the handle. Multiple sizes of the device of the present disclosure would be made available to cover all sizes of handles for carts, strollers, baskets, steering wheels, public seating, public tables, or other items to which a cover is to be applied.

The present disclosure includes disclosure of a disposable sanitary cover made available to consumers in a box with individual covers stacked and pulled through an opening, possibly interleaved so that when one cover is pulled out a new cover is made available. Alternatively, the covers may be provided on rolls in a series separated by perforations, or in a saddle display with perforated edges to permit serial separation as needed. The dispensing system should be displayed in the area of the store in which carts, strollers, baskets and other items with handles are offered to consumers. The device of the present invention could be available for installation by end users or consumers, or by staff of the entity that owns the item to which the device of the present disclosure is applied.

Despite the COVID-19 pandemic, consumers continue to shop in brick-and-mortar stores, and need to shop in those environments. And while shopping at grocery stores, hardware stores, department stores and carrying on other day-to-day activities at other public establishments, consumers will regularly use carts, strollers, baskets, other items with handles, and other repeated-use items that others have already touched or that have already been exposed to possible contaminants from others. As such, consumers continually face exposure to viruses, bacteria, and other pathogens, including COVID-19, particularly through contact with handles for carts, public strollers, baskets or other items. While carts, strollers, baskets and other objects requiring personal touch or handling items help consumers to shop efficiently and perform other day-to-day tasks, the handles of public carts, strollers, baskets and other items can be used by dozens of different shoppers each day. Consumers are therefore forced to face direct contact with viruses, bacteria and other pathogens placed onto the cart, stroller or basket handles by previous users. As a disposable product, the present disclosure includes an easy to use and inspective protective covering that stores can offer or apply in an effort to provide added personal safety for their customers. The device of the present disclosure is a safer, more convenient improvement over the inconsistent results obtained by wipes or wiping used at grocery stores and other retail establishments today. Active sanitizing through wiping is less than completely effective, as sanitizers may only kill a certain percentage of a limited number of contaminants, and that only if applied properly and given sufficient time to react with the contaminants. Likewise, the use of glove may cause allergic reactions and may negatively impact tactile and manual dexterity of the consumer.

The inventions of the present disclosure also offers an advantage over gloves insofar as a merchant or proprietor would have to supply multiple sizes of gloves to accommodate variation in the sizes of its customers hands whereas, with the inventions of the present disclosure, the merchant or proprietor need only supply the small number of sizes needed to fit the items it intends to cover—which is usually only one or two.

Finally, because the inventions of the present disclosure are custom fit and purpose-specific, and given the specific applications of the inventions of the present disclosure, there is a lower likelihood that an employee or customer would steal these coverings of the present disclosure as compared to gloves, which the customers or employees could use for a much broader range of applications and situations.

In some embodiments, the cover may take the form of two rectangular pieces attached (or seamed) on the lateral, shorter sides with a seam at the closed end opposite the open side that opens opposite the closed end. Typically, the polymeric material is extruded as a tube, and the tube is seamed and sealed perpendicular to its length, and then cut down the middle, such that the long end will not need to be sealed.

In one embodiment, the cover may be formed by two generally rectangular pieces attached on the two sides with a seam and having a pleated, flat bottom at the closed end.

In another embodiment, the cover may be formed by two rectangular pieces attached at a closed end with a seam and having two pleated sides that open flat.

These embodiments may be provided with one or more with elastic bands incorporated into the cover at or near the open end.

In another device of the present disclosure, the cover may be employed as a steering wheel cover and, in these embodiments, the cover may be additionally provided with an elastic band around the open end of the bag so as to adapt the cover for extension over, and maintenance in place over, a steering wheel.

Another device of the present disclosure may be employed as a vehicle seat cover, including one of that is adapted to covering the vehicle seat back and seating surfaces, meaning that the cover is a slightly larger version of the vehicle seat shape, so as to be able to be placed on top of the seat to cover the entirety of the user-contact surfaces of the vehicle seat and/or any associated headrests and/or arm portions, whether or not retractable.

Another device of the present disclosure may be employed as a theatre seat cover, including one of that is adapted to covering the theatre seat back and seating surfaces, being, in essence, a slightly larger version of the theatre seat shape, so as to be able to be placed on top of the theatre seat to cover the entirety of the user-contact surfaces and/or any associated headrests or arm portions whether or not retractable.

In another device of the present disclosure, the cover may be employed as a table covering that is adapted to covering a table top, such that the cover is a slightly larger version of the table top, so as to be able to be placed on top of the table to cover the entirety of the table top and at least a portion of one or more sides of the table. Such embodiments likewise may be provided with elastic bands incorporated into the table cover along the cover edge to permit the cover to be extended over and maintained in place over the tabletop.

In other embodiments, the materials may be selected for adhesive or static attachment, such as to a glass table top or table top protectors), or through interference attachments, either from an elastic band or from undersizing the cover compared to the table top and then using the elasticity in the cover material to permit the cover to be expanded for placement over the table top.

The covers of the several embodiments of the disclosure may be contained in and dispensed from holders or dispensers of any type adapted for convenient deployment of the cover, such as through the use of covers of the present invention that are collapsed into a folded confirmation, on rolls in a series separated by perforations, or in a saddle display with perforated edges to permit serial separation as needed; and the combination of the cover and the device it covers and/or the cover and the apparatus that holds or dispenses it before use are all included within the scope of the present disclosure.

The present disclosure includes disclosure of a disposable sanitary cover adapted to cover the contact surface of a handle of a device having same. In at least one embodiment, such a disposable sanitary cover comprises an upper side, a left side, a right side and a bottom such that that the disposable sanitary cover forms a box shape that is open on one end. In at least one embodiment, such a disposable sanitary cover is adapted to engage a handle and cover a substantial portion of said contact surface thereof. In at least one embodiment, such a disposable sanitary cover comprises an inner surface and an outer surface. In an aspect of such an embodiment, the disposable sanitary cover is comprised of a single-ply material. In an aspect of such an embodiment, the disposable sanitary cover is comprised of a multi-ply material. In an aspect of such an embodiment the disposable sanitary cover is composed of two sheets of material joined with a seam on three edges to form a bag shape. In an aspect of such an embodiment the disposable sanitary cover is composed of two sheets of material joined with a seam on the left side and a seam on the right side. In an aspect of such an embodiment the disposable sanitary cover is composed of two sheets of material joined with a seam on the bottom. In an aspect of such an embodiment the inner surface of the disposable sanitary cover includes an adhesive material and the inner surface engages the handle via the adhesive material. In an aspect of such an embodiment the disposable sanitary cover, the inner surface bearing the adhesive material is covered by a removable release liner. In an aspect of such an embodiment the removable release liner is wider than the area of said inner surface bearing said the adhesive surface, thereby forming a lifting edge for initiating removal of the liner. In an aspect of such an embodiment the surface of the disposable sanitary cover contains writings, illustrations, pictures, photographs or indicia, in one or more locations.

The present disclosure includes disclosure of a disposable sanitary cover adapted to cover the contact surface of a handle of a device having same. In at least one embodiment, such a disposable sanitary cover comprises an upper surface and a lower surface and a first and second end; whereby the lower surface of the disposable sanitary cover is adapted to engage said handle at the first end of the disposable sanitary cover and is sufficiently resilient to wrap itself around the handle once placed in contact therewith. In an aspect of such an embodiment, the disposable sanitary cover is comprised of a single-ply material. In an aspect of such an embodiment the disposable sanitary cover is comprised of a multi-ply material. In an aspect of such an embodiment, the lower surface of the disposable sanitary cover includes an adhesive material, and the lower surface engages the handle via the adhesive material. In an aspect of such an embodiment, the inner surface bearing the adhesive material is covered by a removable release liner. In an aspect of such an embodiment, said removable release liner is wider than the area of said inner surface bearing said adhesive material, thereby forming a lifting edge for initiating removal of the liner. In an aspect of such an embodiment, the surface of the disposable sanitary cover contains writings, illustrations, pictures, photographs or indicia, in one or more locations.

The present disclosure includes disclosure of a handle comprising a disposable sanitary cover, said disposable sanitary cover comprising an upper side, a left side, a right side and a bottom such that that the disposable sanitary cover forms a box shape that is open on one end, wherein the disposable sanitary cover is adapted to engage a handle and cover a substantial portion of said contact surface thereof. In an aspect of such an embodiment, the handle is selected from the group of a cart handle, shopping cart handle, stroller handle, or basket handle. In an aspect of such an embodiment, the inner surface of the disposable sanitary cover includes an adhesive material and the inner surface engages the handle via the adhesive material.

The present disclosure includes disclosure of a kit comprising a storage container enclosing a plurality of disposable sanitary covers interwoven in a manner to allow for removal of one single disposable sanitary cover from the kit, said covers adapted to cover the contact surface of a handle of a device having same, the disposable sanitary cover comprises an upper side, a left side, a right side and a bottom such that that it forms a box-shape that is open on one end to engage the handle.

The present disclosure includes disclosure of a method of using a disposable sanitary cover adapted to cover the contact surface of a handle of a device having same, the method comprising the steps of: removing a box-shaped disposable sanitary cover from a dispensing device, aligning the length of the handle with the length of the disposable sanitary cover, lowering the disposable sanitary cover over the handle so as to position the handle inside the cover until the leading edge of the handle comes into contact with the closed end of the disposable sanitary cover whereby said cover engages said handle and covers a substantial portion of said contact surface thereof, said cover being of such size that it may be placed over said contact surface so as to be disposable over said handle so as to cover a substantial portion of said contact surface, and grasping the disposable sanitary cover, with the handle inside it, with one or both hands, so that the user can control the handle, and after use, removing the disposable sanitary cover from the handle.

### BRIEF DESCRIPTION OF THE FIGURES

The embodiments described herein, and other features, advantages, and disclosures contained herein, and the manner of attaining them, will be better understood from the following description in conjunction with the accompanying drawing figures, in which like reference numerals identify like elements, and wherein:

FIG. 1 shows a perspective view of a shopping cart with a disposable sanitary cover shown above the shopping cart handle according to at least one embodiment of the present disclosure;

FIG. 2 shows a perspective view of a disposable sanitary cover lowered in place over and around the shopping cart handle according to at least one embodiment of the present disclosure;

FIG. 3 shows a cross-section view along line 3-3 of FIG. 2 and showing a disposable sanitary cover in place over and around the shopping cart handle according to at least one embodiment of the present disclosure;

FIG. 4 shows cross-section view of an alternative disposable sanitary cover in place over and around the shopping cart handle according to at least one embodiment of the present disclosure;

FIG. 5 shows a top perspective view of a disposable sanitary cover according to at least one embodiment of the present disclosure;

FIG. 6 shows a top perspective view of a disposable sanitary cover according to another embodiment of the present disclosure;

FIG. 7 shows a top perspective view of a disposable sanitary cover according to another embodiment of the present disclosure;

FIG. 8 shows a top perspective view of a disposable sanitary cover according to another embodiment of the present disclosure;

FIG. 9 shows a lower perspective view of a theatre seat or other seat with a disposable sanitary cover shown there above according to at least one embodiment of the present disclosure;

FIG. 10 shows a lower perspective view of a disposable sanitary cover lowered in place over and around the seat and back of a theatre seat or other seat according to at least one embodiment of the present disclosure;

FIG. 11 shows a lateral view of a disposable sanitary cover lowered in place over and around the seat and back of a theatre seat or other seat according to at least one embodiment of the present disclosure;

FIG. 12 shows a lower perspective view of an alternative disposable sanitary cover having an elastic band or portion shown as it would appear once placed upon the seat and back of a theatre seat or other seat (seat not shown) according to at least one embodiment of the present disclosure;

FIG. 13 shows a lower perspective view of an alternative disposable sanitary cover shown as it would appear once placed upon the seat and back of a theatre seat or other seat (seat not shown) according to at least one embodiment of the present disclosure;

FIG. 14 shows a top plan view of an alternative disposable sanitary cover of FIG. 13, shown as it would appear once unfolded a placed flat upon a surface according to at least one embodiment of the present disclosure;

FIG. 15 shows a lateral perspective view of a theatre seat or other seat with arms with an alternative disposable sanitary cover shown aside a theatre seat or other seat with arms according to at least one embodiment of the present disclosure;

FIG. 16 shows a lateral perspective view of a disposable sanitary cover moved in place over and around the seat and back of a theatre seat or other seat with arms according to at least one embodiment of the present disclosure;

FIG. 17 shows a lateral perspective view of a vehicle steering wheel with a disposable sanitary cover shown aside a vehicle steering wheel in position to be placed therearound according to at least one embodiment of the present disclosure;

FIG. 18 shows a lateral perspective view of a disposable sanitary cover as it is expanded and moved in place over and around a vehicle steering wheel according to at least one embodiment of the present disclosure;

FIG. 19 shows a lateral perspective view of a disposable sanitary cover in place over and around a vehicle steering wheel according to at least one embodiment of the present disclosure;

FIG. 20 shows a lateral perspective view of a vehicle steering wheel with an alternative disposable sanitary cover having an elastic band or portion shown aside a vehicle steering wheel in position to be placed therearound according to at least one embodiment of the present disclosure;

FIG. 21 shows a lateral perspective view of an alternative disposable sanitary cover as it is expanded and moved in place over and around a vehicle steering wheel according to at least one embodiment of the present disclosure;

FIG. 22 shows a lateral perspective view of an alternative disposable sanitary cover in place over and around a vehicle steering wheel according to at least one embodiment of the present disclosure;

FIG. 23 shows an upper perspective view of a table with a disposable sanitary cover shown above the tabletop according to at least one embodiment of the present disclosure;

FIG. 24 shows a lower perspective view of a disposable sanitary cover lowered in place over and around the tabletop according to at least one embodiment of the present disclosure;

FIG. 25 shows a lateral elevation view of a disposable sanitary cover lowered in place over and around the tabletop according to at least one embodiment of the present disclosure; and

FIG. 26 shows a upper perspective view of an alternative disposable sanitary cover having an elastic band or portion shown as it would appear once placed upon a tabletop according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

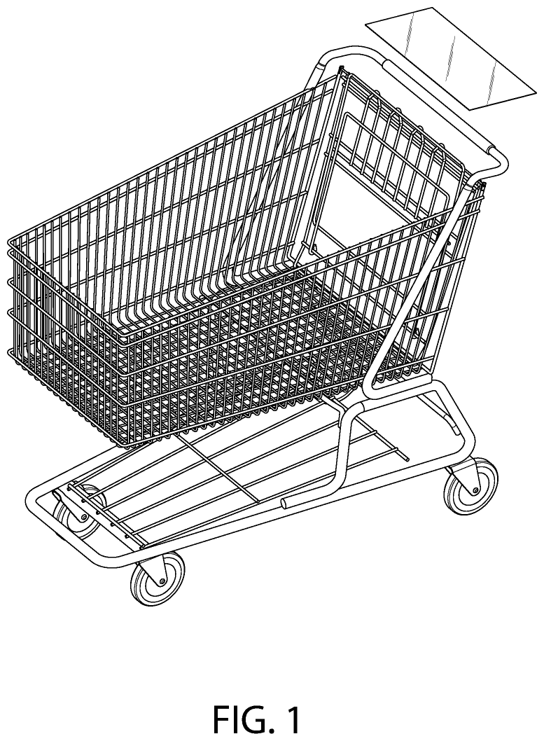

FIG. 1 is a perspective view of a shopping cart with a disposable sanitary cover in a bag shape shown above the shopping cart handle according to at least one embodiment of the present disclosure. According to an embodiment, the disposable sanitary cover is constructed of an inelastic or minimally elastic synthetic or natural material to be deployed over the handle of a standard shopping cart of the type used in grocery stores or other retail locations. According to other embodiments, the cover is used to cover the handle of another type of cart, a stroller, a basket or other public item containing a handle. It will be appreciated by one of skill in the art that the disposable sanitary cover, once deployed, will cover most or all of the handle to provide a sanitary barrier for the consumer against viruses, bacteria and other pathogens, as well as dirt, that may be coating the handle.

According to an embodiment, the upper surface and the lower surface may be joined at the sides and closed end of the cover with seams to define an open space between the upper surface and lower surface, without separately defined sides or bottom (i.e., seams in place of the sides and bottom of the bag rather than the defined sides and bottom shown on FIG. 1). This embodiment may be sized to fit more loosely over the handle of a cart, stroller, basket or other item with handles in order to accommodate the lack of depth at the closed end and sides of the bag that is the cover.

According to an embodiment, the disposable sanitary cover is a one-ply material. According to another embodiment, the disposable sanitary cover is a multiple-ply material. According to an embodiment of the present disclosure, the disposable sanitary cover possesses elastic qualities. According to an embodiment the disposable sanitary cover may be constructed of plastic, paper, fabric, or other synthetic or natural material. According to an embodiment, the cover may include writings, illustrations, pictures, photographs, or other printed, imprinted, embossed imagery in one or more locations and using one or more fonts or styles and using one or more inks, toners, paints or other materials, for the purpose of setting forth or depicting logos, advertising materials, safety warnings, instructional, inspirational, or humorous material, or other communications of any nature. According to an embodiment, a multiple-ply disposable sanitary cover is made of the same material or two or more different materials, including using an inner ply, the layer that would contact the handle, made of a strong barrier material that potentially is coated with an adhesive. According to an embodiment, the outside ply of the disposable sanitary cover is made of the same or a different material, so that the outside layer of the disposable sanitary cover features the same or different properties as the inside layer the disposable sanitary cover. According to an embodiment, the outside layer of the disposable sanitary cover is coated or impregnated with antiviral, antibacterial or other chemicals. According to an embodiment, the outside layer of the disposable sanitary cover is constructed of padded material that is more pleasurable for the consumer to hold, provides greater tactility or grip, or that is insulating.

According to an embodiment the disposable sanitary cover is of variable size, such that the cover is able to be inverted and slipped over handless of carts, public strollers, baskets or other items of various sizes, with typical embodiments having a width from 6 to 33 inches, although other embodiments can have widths lesser than 6 inches or greater than 33 inches. According to an embodiment, the length of the cover (from closed end to open end) is 6 inches, although other formulations can have lengths lesser or greater than 6 inches. According to an embodiment, the closed end of the cover is a defined bottom, so that the cover forms an empty space bounded by the closed end and the remaining sides of the cover, with the depth of the space being of varying depths. According to an embodiment, the closed end of the cover is a seam.

According to an embodiment, the disposable sanitary cover is affixed to the handle of a cart, stroller, basket or other item by friction or snugness. According to an embodiment, the disposable sanitary cover is affixed to the handle of a cart, stroller, basket or other item by other means, including one or more adhesive strips attached to the cover and pressed against the cart or another portion of the cover, activating the adhesive and securing the cover to the handle. The adhesive may include a release liner, which would be removed prior to attaching the cover. According to an embodiment, the release liner is wider than the adhesive coating, resulting in an edge void that affords a lifting edge for removal of the release liner.

According to an embodiment, as an additional means for affixing the cover to the handle, all or a portion of the inner surface of the bag that is the disposable sanitary cover is fully or partially coated with an adhesive. According to an embodiment of the present disclosure, in order to attach the disposable sanitary cover, portions of the disposable sanitary cover are pressed onto the cart, stroller, or basket handle or onto other portions of the disposable sanitary cover, activating the adhesive and securing the disposable sanitary cover to or around at least a portion of the handle. According to an embodiment, the adhesive includes a release liner, which may be removed prior to attaching the disposable sanitary cover. According to an embodiment, the release liner is wider than the adhesive coating, creating an edge void that affords lifting edge for removal of the release liner.

According to an embodiment of the present disclosure, the disposable sanitary cover is constructed out of a material with elastic material as a means of attaching the disposable sanitary cover to the handle. According to such an embodiment, the open end of the cover is stretched over the handle of a cart, stroller, basket or other item and is held in place due to the snugness or friction of the tight contact between the cover and the handle.

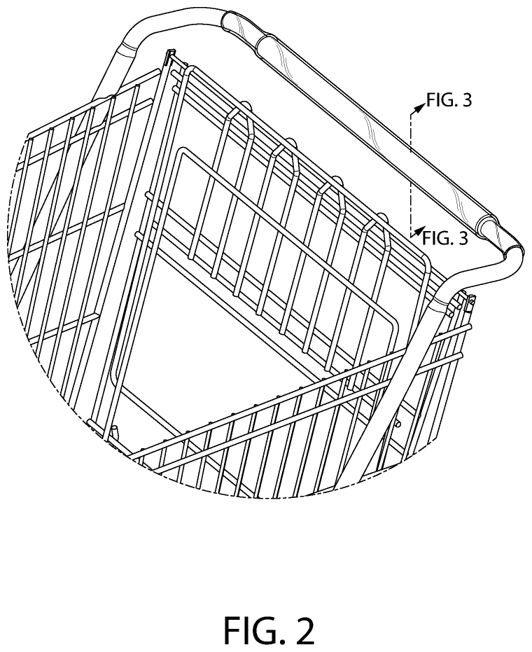

FIG. 2 is a perspective view of a disposable sanitary cover lowered over and around a shopping cart handle according to at least one embodiment of the present disclosure. According to an embodiment, the disposable sanitary cover is secured to the handle using one of the attachment methods described above.

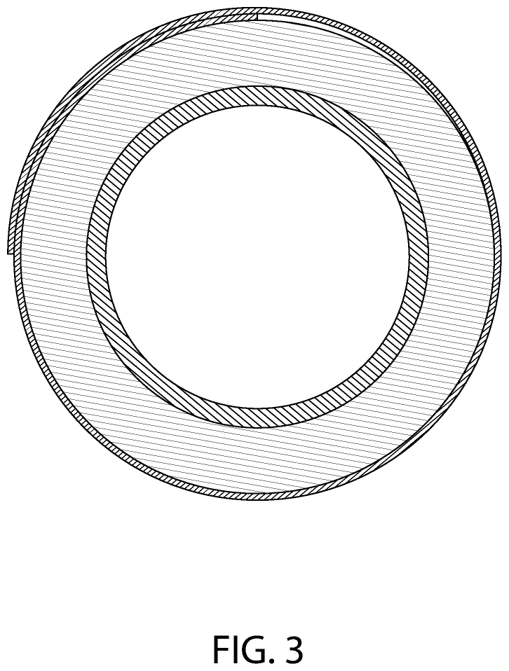

FIG. 3 shows a cross-section view along line 3-3 of FIG. 2 and showing a disposable sanitary cover in place over and around the shopping cart handle according to at least one embodiment of the present disclosure.

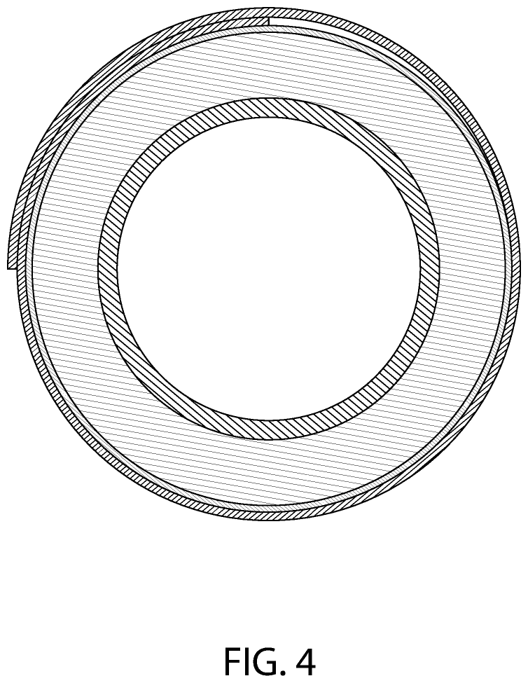

FIG. 4 shows cross-section view of an alternative disposable sanitary cover in place over and around the shopping cart handle according to at least one embodiment of the present disclosure, wherein the handle may have additional material layers as shown below the cover.

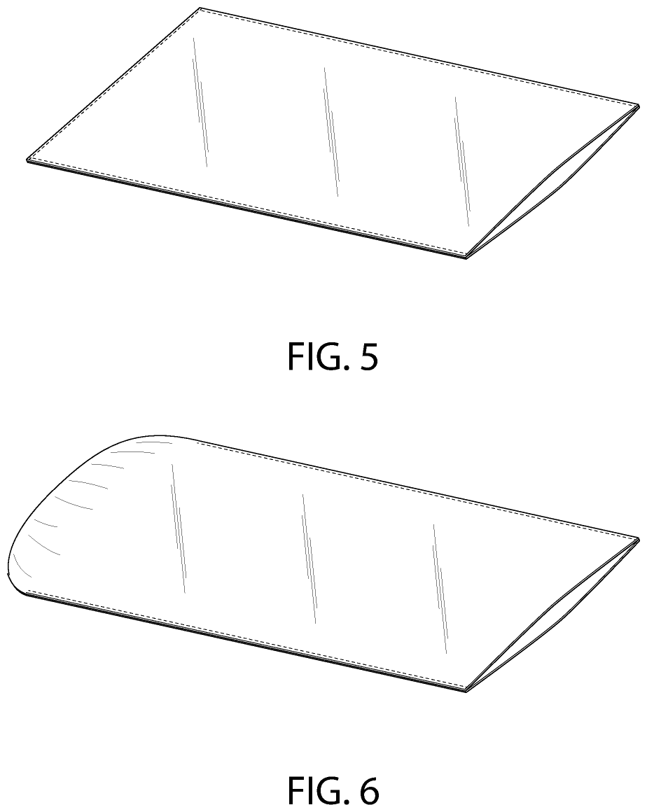

FIG. 5 shows a top perspective view of a disposable sanitary cover according to at least one embodiment of the present disclosure, this cover featuring stitched seams about three sides with an open end.

FIG. 6 shows a top perspective view of a disposable sanitary cover according to another embodiment of the present disclosure, this cover featuring stitched seams on two lateral sides with an open end and an opposite closed end that is blown or molded to a reduced, rounded side.

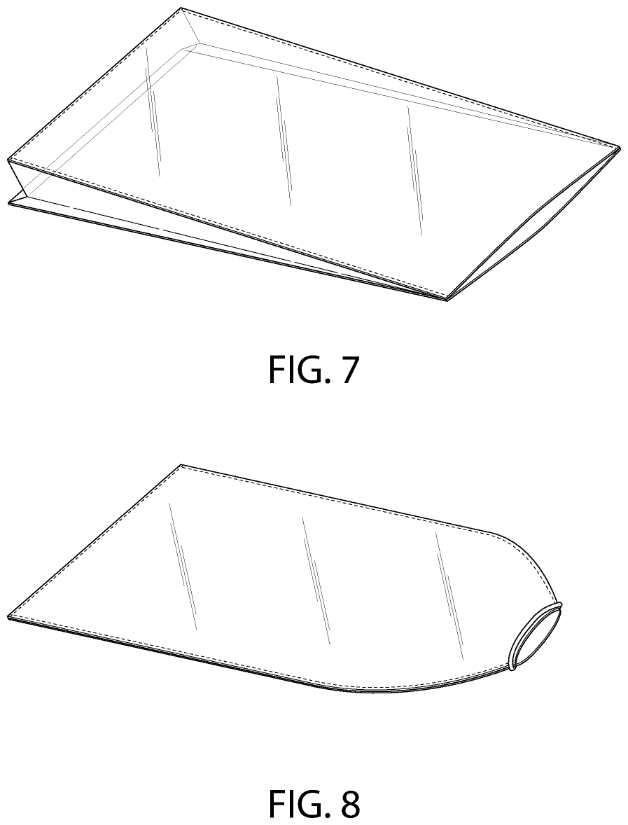

FIG. 7 shows a top perspective view of a disposable sanitary cover according to another embodiment of the present disclosure, this cover featuring stitched seams on three lateral sides with an open end and an opposite end provided with gussets.

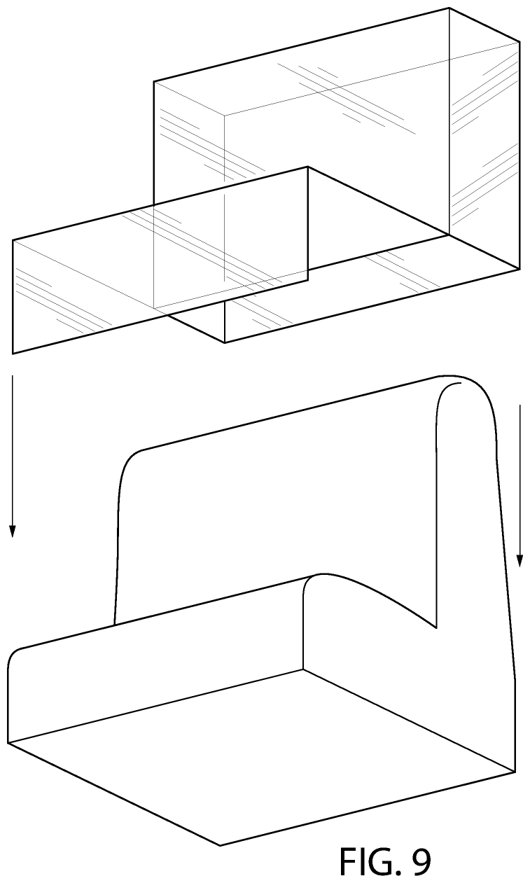

FIG. 8 shows a top perspective view of a disposable sanitary cover according to at least one embodiment of the present disclosure, this cover featuring stitched seams about three sides with an open end, and an opposite end provided with an elastic band.

According to an embodiment, the disposable sanitary cover may be removed from the handle by grasping the cover at any point and pulling the cover off of the handle. According to an embodiment, the disposable sanitary cover may be removed by a tab placed for this purpose on an edge of the disposable sanitary cover, and pulling the disposable sanitary cover off of the handle of the cart, stroller, basket or other item.

An embodiment can be used not only with public carts, strollers, baskets and other items with handles, but for any private cart, stroller, basket or other items with handles when there is a desire to protect against germs, dirt or other substances that may have been deposited on such a handle. Additionally, an embodiment can be used on public or private carts, strollers, baskets and other items with handles in order to protect against germs, dirt and other substances being deposited on the handle.

In other embodiments, FIGS. 9-16 show the seat cover, and these may have rectangular cut outs at the top of the cover (where it contacts the top of the seat) allowing for easier removal and adjustment. The cover may be adapted to be slid over the car seat, or so it may be slid over the headrest, or both. In one embodiment, a cutout at the bottom corner(s) of the cover may be provided for ease of manufacturing. In these embodiments, a slit may be provided so as to provide, when installed, a square cut-out of one of the flat sides of the cover to facilitate accommodation of the seat shape. In other embodiments, the covers need not be seamed or joined at the corners. Fewer required cut-outs may reduce manufacturing costs.

FIG. 9 shows a lower perspective view of a theatre seat or other seat with a disposable sanitary cover shown there above according to at least one embodiment of the present disclosure. The cover is pre-formed to fit over the seat surfaces and may be sized to fit snuggly to prevent displacement during use.

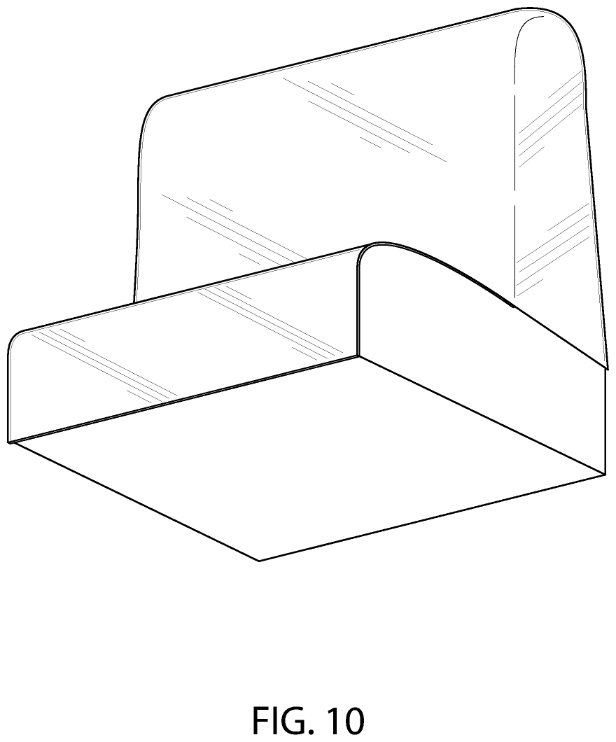

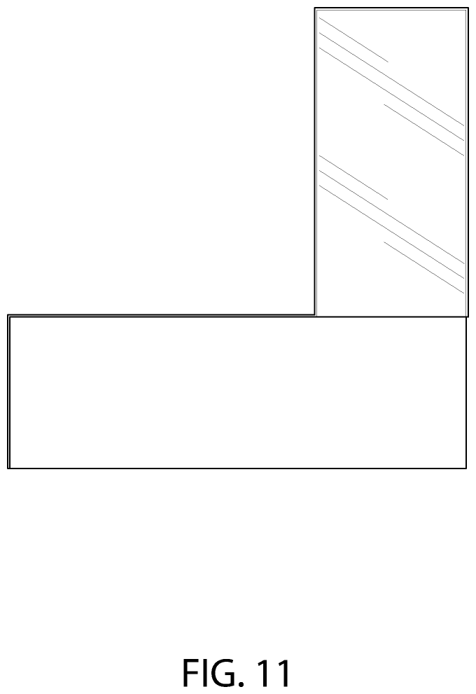

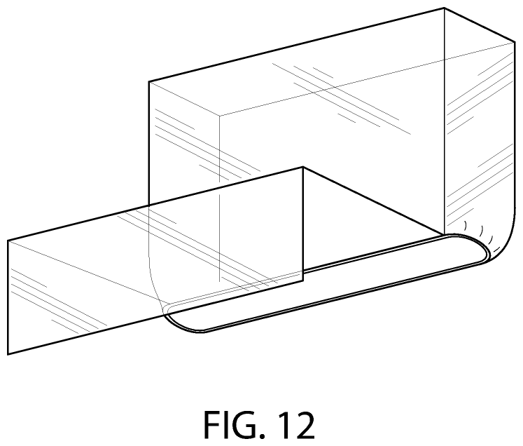

FIG. 10 shows a lower perspective view of a disposable sanitary cover lowered in place over and around the seat and back of a theatre seat or other seat according to at least one embodiment of the present disclosure. This view shows the cover in place to protect the user from contact with unsanitary surfaces of the seat. FIG. 11 shows a lateral view of a disposable sanitary cover lowered in place over and around the seat and back of a theatre seat or other seat according to at least one embodiment of the present disclosure. The seat may be rounded in front or have an angled front seat portion as shown in this view.

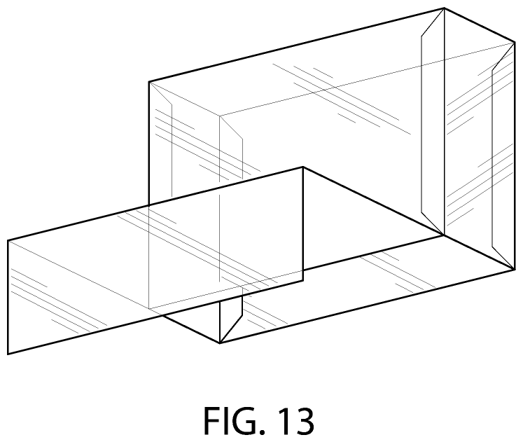

FIG. 12 shows a lower perspective view of an alternative disposable sanitary cover having an elastic band or portion shown as it would appear once placed upon the seat and back of a theatre seat or other seat (seat not shown) according to at least one embodiment of the present disclosure. This embodiment shows the open portion that covers the seat back being fitted with an elastic band to maintain the cover in place during use, while permitting it to be easily removed.

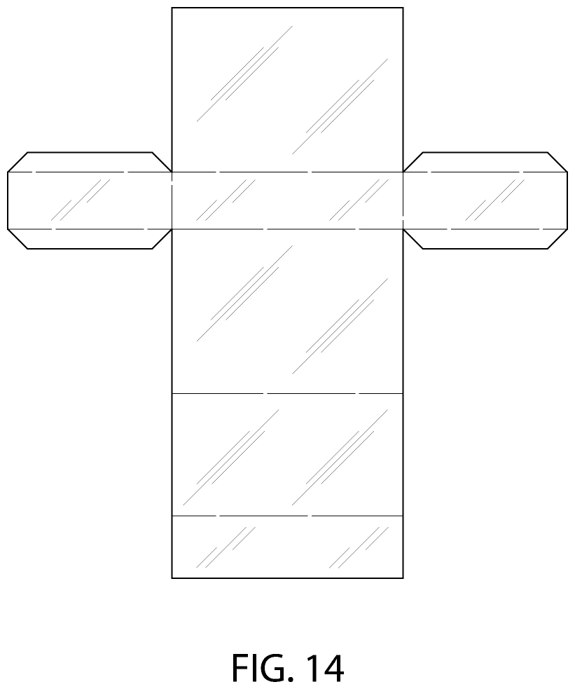

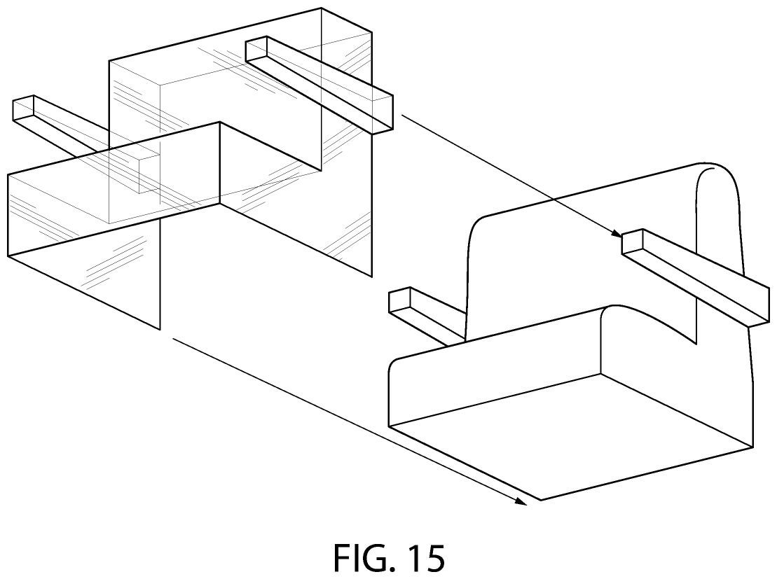

FIG. 13 shows a lower perspective view of an alternative disposable sanitary cover shown as it would appear once placed upon the seat and back of a theatre seat or other seat (seat not shown) according to at least one embodiment of the present disclosure. This cover is created as a single piece of plastic or other material and may be designed to be folded and adhered into a shaped cover. FIG. 14 shows a top plan view of an alternative disposable sanitary cover of FIG. 13, shown as it would appear once unfolded a placed flat upon a surface according to at least one embodiment of the present disclosure, the cover having wing portions adapted to overlapped and adhered in place to form a final conformation.

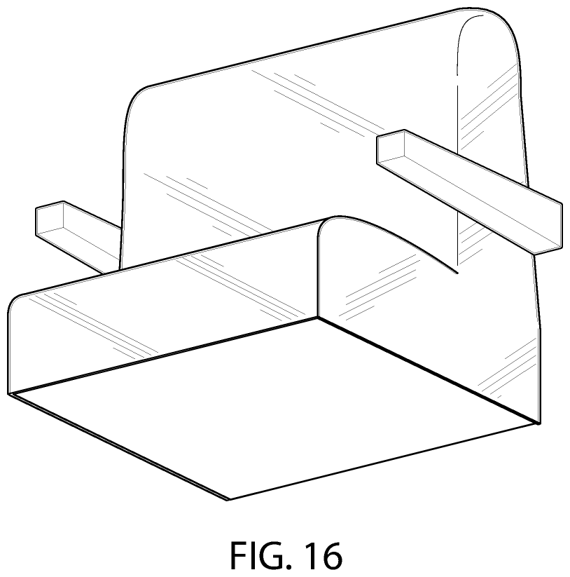

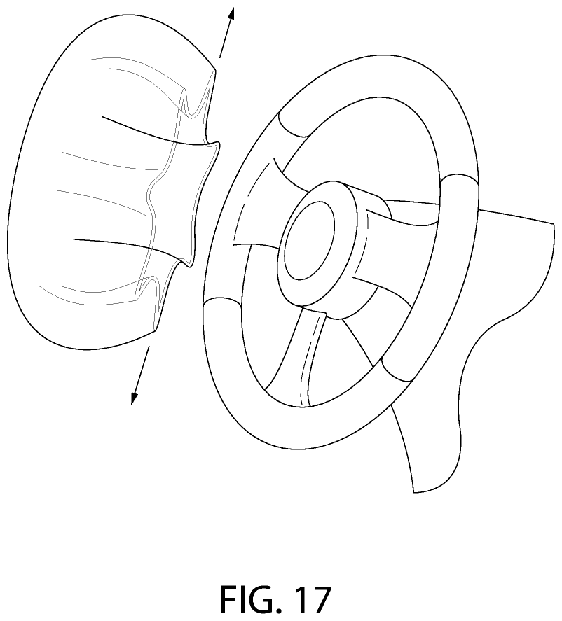

FIG. 15 shows a lateral perspective view of a theatre seat or other seat with arms with an alternative disposable sanitary cover shown aside a theatre seat or other seat with arms according to at least one embodiment of the present disclosure. FIG. 16 shows a lateral perspective view of a disposable sanitary cover once moved in place over and around the seat and back of a theatre seat or other seat with arms according to at least one embodiment of the present disclosure.

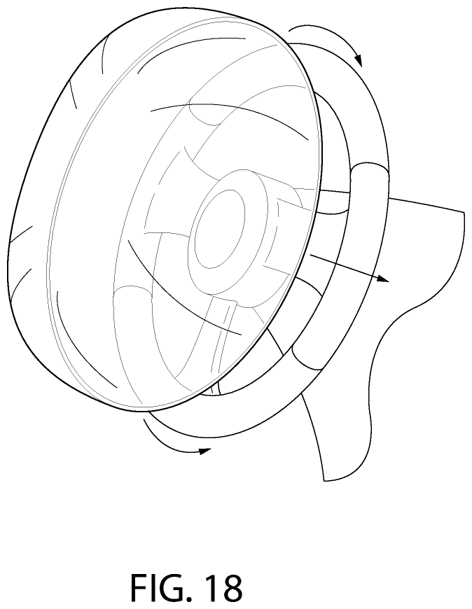

In some embodiments, the cover may be employed as a steering wheel cover and in these embodiments a cover such as that shown in FIGS. 17-22, and in some embodiments may be additionally provided with an elastic band around the open end of the bag so as to adapt the cover for extension over and maintenance in place over a steering wheel.

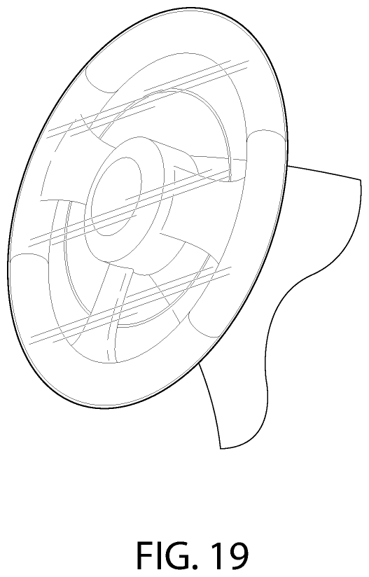

FIG. 17 shows a lateral perspective view of a vehicle steering wheel with a disposable sanitary cover shown aside a vehicle steering wheel in position to be placed therearound according to at least one embodiment of the present disclosure. This cover may be blown or otherwise molded to be slightly narrower at its open end to permit it to be expanded. FIG. 18 shows a lateral perspective view of a disposable sanitary cover as it is expanded and moved in place over and around a vehicle steering wheel according to at least one embodiment of the present disclosure. FIG. 19 shows a lateral perspective view of a disposable sanitary cover in place over and around a vehicle steering wheel according to at least one embodiment of the present disclosure.

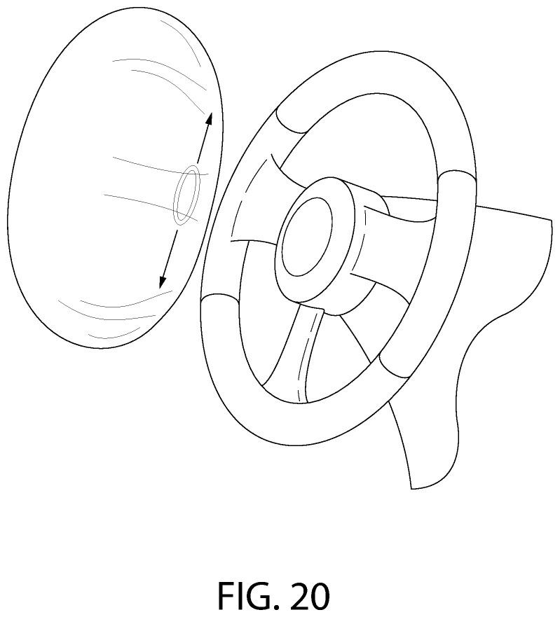

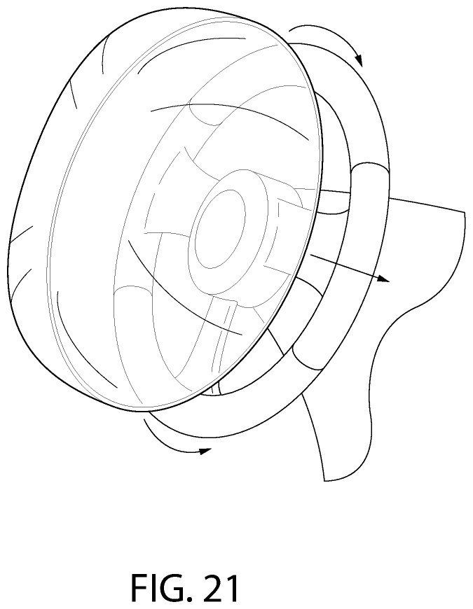

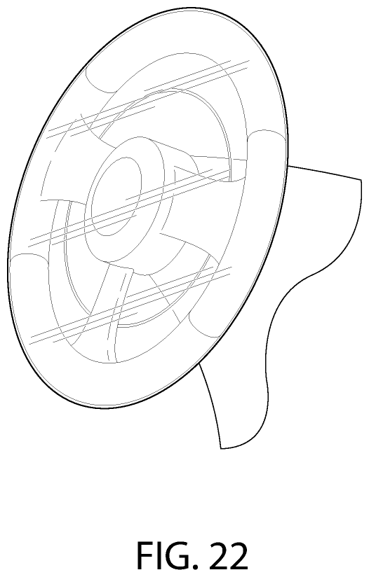

FIG. 20 shows a lateral perspective view of a vehicle steering wheel with an alternative disposable sanitary cover having an elastic band or portion on its open side and shown aside a vehicle steering wheel in position to be placed therearound according to at least one embodiment of the present disclosure. FIG. 21 shows a lateral perspective view of an alternative disposable sanitary cover as it is expanded through expansion of the elastic band and moved in place over and around a vehicle steering wheel according to at least one embodiment of the present disclosure. FIG. 22 shows a lateral perspective view of an alternative disposable sanitary cover in place over and around a vehicle steering wheel according to at least one embodiment of the present disclosure.

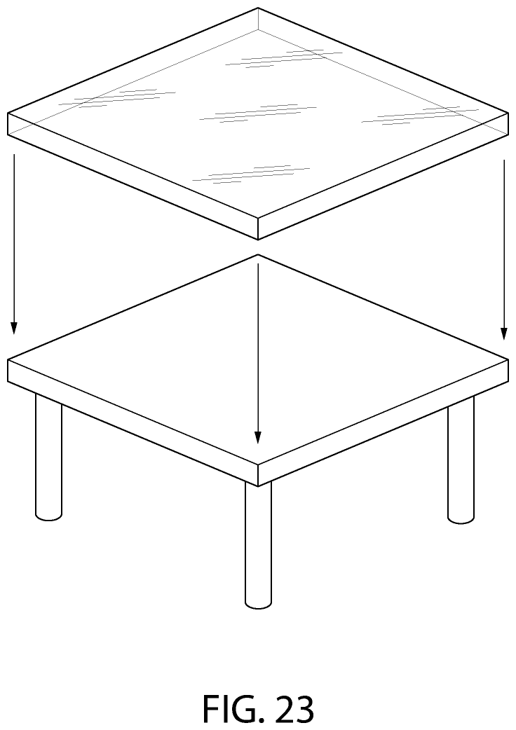

In other embodiments, the cover may be employed as a tabletop cover such as that shown in FIGS. 23-26, and in some embodiments may be additionally provided with an elastic band around the open end of the bag so as to adapt the cover for extension over and maintenance in place over the tabletop.

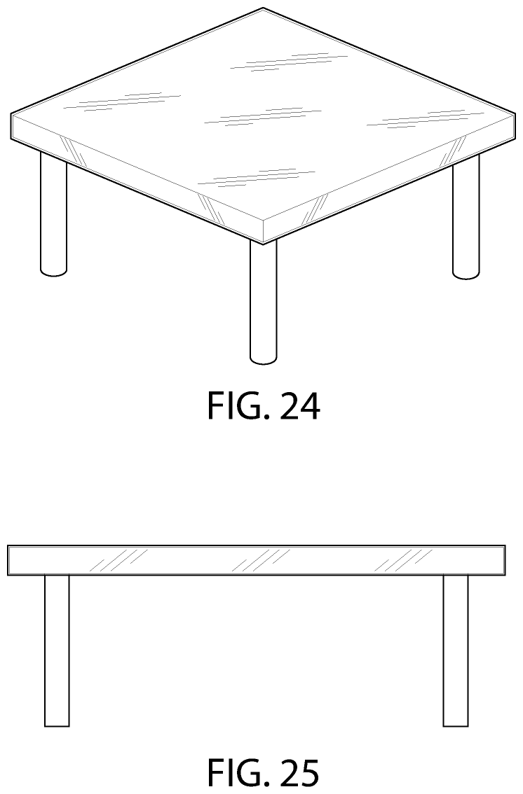

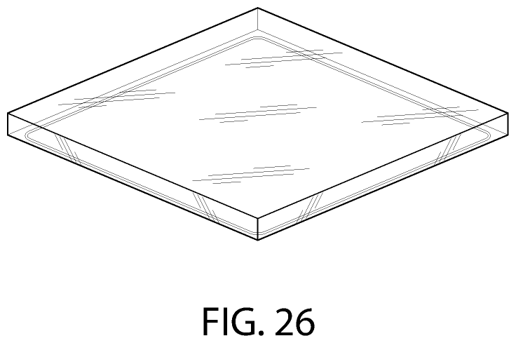

FIG. 23 shows an upper perspective view of a table with a disposable sanitary cover shown above the tabletop according to at least one embodiment of the present disclosure, in this case for a square tale top, though other shapes may be accommodated through the cover being blown or otherwise molded to create a fitting shape that captures the tabletop. FIG. 24 shows a lower perspective view of a disposable sanitary cover lowered in place over and around the tabletop according to at least one embodiment of the present disclosure. FIG. 25 shows a lateral elevation view of a disposable sanitary cover lowered in place over and around the tabletop according to at least one embodiment of the present disclosure.

FIG. 26 shows an upper perspective view of an alternative disposable sanitary cover having an elastic band or portion shown as it would appear once placed upon a tabletop according to at least one embodiment of the present disclosure. Likewise, other shapes may be accommodated through the cover being blown or otherwise molded to create a fitting shape that captures the tabletop. The cover may be expanded through expansion of the elastic band and moved in place over and around the tabletop, and also removed after use for disposal.

All of the foregoing described variants fall within the true spirit and scope of the invention. With respect to the above descriptions, it is to be understood that the optimum dimensional relationships for the disposable sanitary cover for publicly used carts, strollers, baskets and other items containing handles, including variations in size, materials, shape, form, function, manner of operation, assembly and use, are deemed readily apparent and obvious to one skilled in the art, and all equivalent relationships to those illustrated in the drawings or described in these specifications are intended to be encompassed by the present disclosure. The present disclosure includes any disposable materials that can be fabricated into the embodiments disclosed herein, potentially with adhesive strips, adhesive coatings, or other coatings, of any type; with varying characteristics, such as impermeability, softness, durability, elasticity, insulation; antiviral, antibacterial, or any other anti-pathogenic or protective nature; in one-ply versions or combined in any number of multiple-ply combinations. For example, according to an embodiment of the present disclosure, a one-ply, plastic cover of six inches in length, twenty-six inches in width, and one inch in depth that has no adhesive materials is intended to be encompassed by the present disclosure. The following example is another embodiment of the present disclosure: a five-inch long, thirty-four-inch wide cover with a seam bottom (i.e., two rectangular sheets joined together along three edges to form a cover with a space defined by the edges of the cover, as opposed to a cover with a defined bottom at the closed end), having a two-ply disposable sanitary cover comprised of an inner durable plastic ply, a soft fabric outside ply that is impregnated with antiviral agents, and featuring a two-inch adhesive tab with a release strip. Therefore, the foregoing is considered as illustrative only of the principles of the disclosures. Further, because the possibility of modifications and changes will readily occur to those skilled in the art, it is not desired to limit the invention to the exact construction and operation shown and described herein, and, accordingly, all suitable modifications and equivalents may be resorted to, falling within the scope of the disclosure.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

I claim:

1. A disposable sanitary cover adapted to cover the contact surface of a handle of a device having same, said disposable sanitary cover comprising an upper side, a left side, a right side and a bottom such that that the disposable sanitary cover forms a box shape that is open on one end, wherein the disposable sanitary cover whereby said cover is adapted to engage a handle and cover a substantial portion of said contact surface thereof;
wherein said disposable sanitary cover comprises an inner surface and an outer surface.

2. The disposable sanitary cover of claim 1, wherein the disposable sanitary cover is comprised of a single-ply material.

3. The disposable sanitary cover of claim 1, wherein the disposable sanitary cover is comprised of a multi-ply material.

4. The disposable sanitary cover of claim 1, wherein the disposable sanitary cover is composed of two sheets of material joined with a seam on three edges to form a bag shape.

5. The disposable sanitary cover of claim 1, wherein the disposable sanitary cover is composed of two sheets of material joined with a seam on the left side and a seam on the right side.

6. The disposable sanitary cover of claim 1, wherein the cover is composed of two sheets of material joined with a seam on the bottom.

7. The disposable sanitary cover of claim 1, wherein:
the inner surface of the disposable sanitary cover includes an adhesive material; and
the inner surface engages the handle via the adhesive material.

8. The disposable sanitary cover of claim 7, wherein the inner surface bearing the adhesive material is covered by a removable release liner.

9. The disposable sanitary cover of claim 8, wherein said removable release liner is wider than the area of said inner surface bearing said the adhesive surface, thereby forming a lifting edge for initiating removal of the liner.

10. The disposable sanitary cover of claim 1, wherein the surface of the disposable sanitary cover contains writings, illustrations, pictures, photographs or indicia, in one or more locations.

11. A disposable sanitary cover adapted to cover the contact surface of a handle of a device having same, said disposable sanitary cover comprising an upper surface and a lower surface and a first and second end; whereby the lower surface of the disposable sanitary cover is adapted to engage said handle at the first end of the disposable sanitary cover and is sufficiently resilient to wrap itself around the handle once placed in contact therewith.

12. The disposable sanitary cover of claim 11, wherein the disposable sanitary cover is comprised of a single-ply material.

13. The disposable sanitary cover of claim 11, wherein the disposable sanitary cover is comprised of a multi-ply material.

14. The disposable sanitary cover of claim 11, wherein:
the lower surface of the disposable sanitary cover includes an adhesive material; and
the lower surface engages the handle via the adhesive material.

15. The disposable sanitary cover of claim 14, wherein the inner surface bearing the adhesive material is covered by a removable release liner.

16. The disposable sanitary cover of claim 15, wherein said removable release liner is wider than the area of said inner surface bearing said adhesive material, thereby forming a lifting edge for initiating removal of the liner.

17. The disposable sanitary cover of claim 11, wherein the surface of the disposable sanitary cover contains writings, illustrations, pictures, photographs or indicia, in one or more locations.

18. A handle comprising a disposable sanitary cover, said disposable sanitary cover comprising an upper side, a left side, a right side and a bottom such that that the disposable sanitary cover forms a box shape that is open on one end, wherein the disposable sanitary cover is adapted to engage a handle and cover a substantial portion of said contact surface thereof.

19. The handle of claim 18 wherein the handle is selected from the group of a cart handle, shopping cart handle, stroller handle, or basket handle.

20. The handle of claim 18 wherein the inner surface of the disposable sanitary cover includes an adhesive material; and
the inner surface engages the handle via the adhesive material.

21. A kit comprising a storage container enclosing a plurality of disposable sanitary covers interwoven in a manner to allow for removal of one single disposable sanitary cover from the kit, said covers adapted to cover the contact surface of a handle of a device having same;
wherein said disposable sanitary cover comprises an upper side, a left side, a right side and a bottom such that that it forms a box-shape that is open on one end to engage the handle.

22. A method of using a disposable sanitary cover adapted to cover the contact surface of a handle of a device having same , said method comprising the steps of:
removing a box-shaped disposable sanitary cover from a dispensing device;
aligning the length of the handle with the length of the disposable sanitary cover;
lowering the disposable sanitary cover over the handle so as to position the handle inside the cover until the leading edge of the handle comes into contact with the closed end of the disposable sanitary cover whereby said cover engages said handle and covers a substantial portion of said contact surface thereof, said cover being of such size that it may be placed over said contact surface so as to be disposable over said handle so as to cover a substantial portion of said contact surface; and
grasping the disposable sanitary cover, with the handle inside it, with one or both hands, so that the user can control the handle; and
after use, removing the disposable sanitary cover from the handle.
